(19) United States
(12) Patent Application Publication
(10) Pub. No.: US 2012/0061315 A1
(43) Pub. Date: Mar. 15, 2012

(54) Method of Recovering Potassium from Waste Waters for Use in Purification of Waste Water, including the Waste Water from which the potassium is Recycled, while retaining the Potassium in forms suitable for use as a Nutrient in Growing Microbes, Plants and Algae

(76) Inventor: Gerald J GROTT, Phoenix, AZ (US)

(21) Appl. No.: 13/248,679

(22) Filed: Sep. 29, 2011

Related U.S. Application Data
(63) Continuation-in-part of application No. 11/978,890, filed on Oct. 30, 2007, now Pat. No. 7,947,185.

(51) Int. Cl. C02F 3/00

(52) U.S. Cl. 210/601

(57) ABSTRACT

A method for recovering and/or utilizing potassium from waste waters for a plurality of applications. As algae and plants are able to survive and flourish in environments with high salt concentrations, waste waters containing potassium can be applied as fertilizers to the growth of microbes, algae and plants. The microbes, plants, and algae are able to absorb the necessary nutrients, such as nitrogen and potassium, from the waste waters. After depletion of the potassium content from the waste water, that waste water can then be treated to separate other contaminants. In another aspect of the present invention, the potassium content may be first separated from the waste water to be applied for growth of microbes, plants, and algae and again used for regeneration of cation resins in specific potassium forms. The remaining contaminants that are separated through treatment of the waste water can be utilized for different productions.

The current application is a continuation in part that claims a priority to the U.S. non-provisional patent application Ser. No. 11/978,890 filed on Aug. 29, 2008.

### FIELD OF THE INVENTION

The present invention relates generally to a process and method for recycling potassium from waste waters for beneficial uses in including increased recovery of oil from wells. Processes and methods are also described to include recycling co-product water, brines and salts for other beneficial uses, and chemicals for beneficial use. Particularly, potassium chloride and chemicals produced from potassium chloride are useful in purification of water while the potassium is also recovered in a form useful as a nutrient for microbes, plants, and algae. The microbes are fed with small plants and/or algae grown separately or within water cycled through the oil well while the microbes produce materials which aid in recovering oil faster and more completely. In this way the recycled potassium aids in financing the path to both lower cost desalination of brackish groundwater to potable water and Sustainability of Fiber, Food and Fuel without oil wells.

### BACKGROUND OF THE INVENTION

The prior U.S. non-provisional patent application Ser. No. 13,087,214, the U.S. non-provisional patent application Ser. No. 13,158,325, and the U.S. provisional patent application 61495912 describe various uses for recycled water, brines, and salts along with various methods for separating the products for recycling. The present invention is a continuation of the prior patents listed above.

It has long been recognized that many waste waters such as run-off and drainage from fertilized fields contain potassium as the carbonate, chloride, sulfate, or nitrate, and even as the salt of an organic acid, and usually along with other inorganic salts. The potassium in these waste waters has contributed to contamination of groundwater and streams. While major efforts have been made to remove nitrates from these contaminated waters and my U.S. patent applications 13087214 and 13158325 describe the recycling of such nitrates to beneficial use, and now it has been found that potassium in waste waters can be recycled in several forms to beneficial use by a number of different methods. This application uses the example of how the potassium in produced water from wells in the Monterrey Shale Oil and Natural Gas formation in the agricultural areas of California can be recycled in a manner that at least some of the water and other salts are also separated for beneficial use, including the desalination of water to meet standards for UltraPure Water as used in manufacture of computer chips, as for making steam for high pressure turbines, and manufacture of medicines and pharmaceuticals.

With potassium being a major nutrient for microbes, plants, and algae in both fresh and salty water, the present invention introduces a method of extracting the potassium content from the waste waters. Microbes, plants, and algae are able to grow in harsh varying environment with varying salinity, varying sunlight, and varying temperatures. The special characteristics of microbes, plants and algae that have adapted to a wide range of natural conditions, as well as algae selected by use of imposed special conditions, or genetic modification, make microbes, plants, and algae suitable for growth using the water produced from oil wells, and even use of microbes within the oil well itself, a practice called Microbial Enhanced Oil Recovery. The American Petroleum Institute estimates that the annual cost of disposal of Produced Water from Oil and Gas Wells is some $18 Billion per annum. The USGS estimates that old oil fields either capped or are marginally productive due to the high ratio of water produced along with the oil still containing, on average, twice as much oil as ever produced.

The estimate is that 325 Billion barrels of oil remains in those long producing formations at or near the end of their economic life. The U.S. Department of Energy estimates that use of currently available technology can recover about as much additional oil as has been produced from these formations to date. The present invention addresses the use of waste waters in general and particularly produced water from oil and gas wells in assisting our nation's path to sustainability through expanded use of wastewaters, and produced water from oil and gas wells. Additionally, the commercial value of algae is advantageous as food, bio-fuels, as fertilizer on land crops. Tests have shown that the growth of algae in ponds is also sustainable with suitable biological oxygen demand, nitrogen, and potassium and phosphate consumption. Along with any other nutrient contaminants in the waste waters, the potassium content is consumed by the halophytic microbes, plants and algae for growth. The resulting water used for the production of algae is a reduced amount of contamination by potassium and other nutrients.

### BRIEF DESCRIPTION OF THE DRAWINGS

FIG. 1 shows an embodiment of the present invention where the produced water is directly applied to the growth of plants and algae. The used water is then taken and treated for recovery of usable salts.

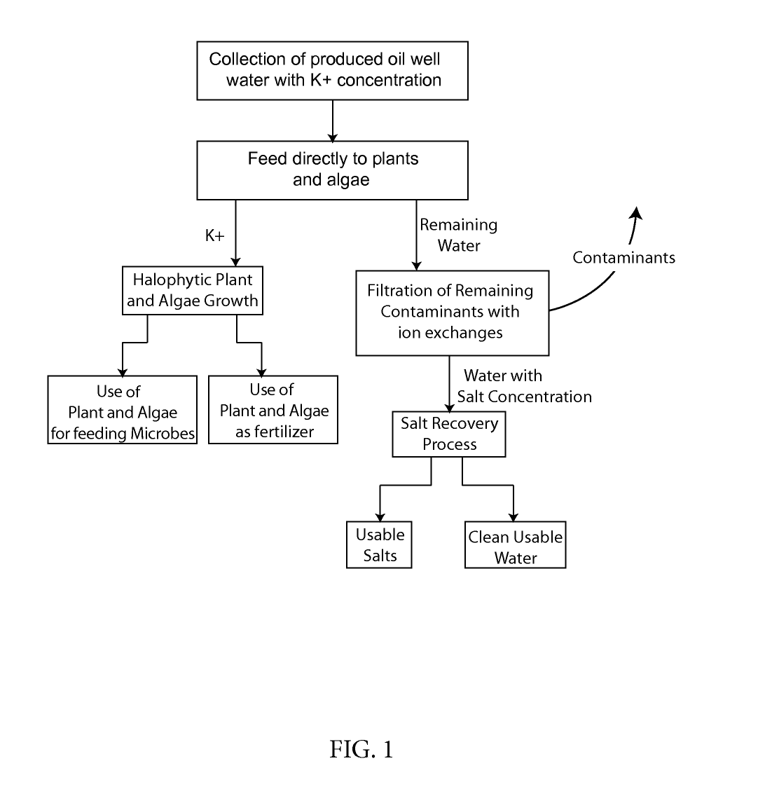

FIG. 2 shows another embodiment of the present invention where the produced water from oil wells is treated by ion exchanges to extract each contaminant individually and separately. The potassium is separated and directly applied to plants and algae as fertilizer feed. The water is then treated for recovery of usable salts. When separated from at least the sodium salts in the water, the potassium works as fertilizer for use in agriculture, hydroculture, and aquaculture, and is also a nutrient for algae. Additionally, the calcium and magnesium salts are useful as soil amendments.

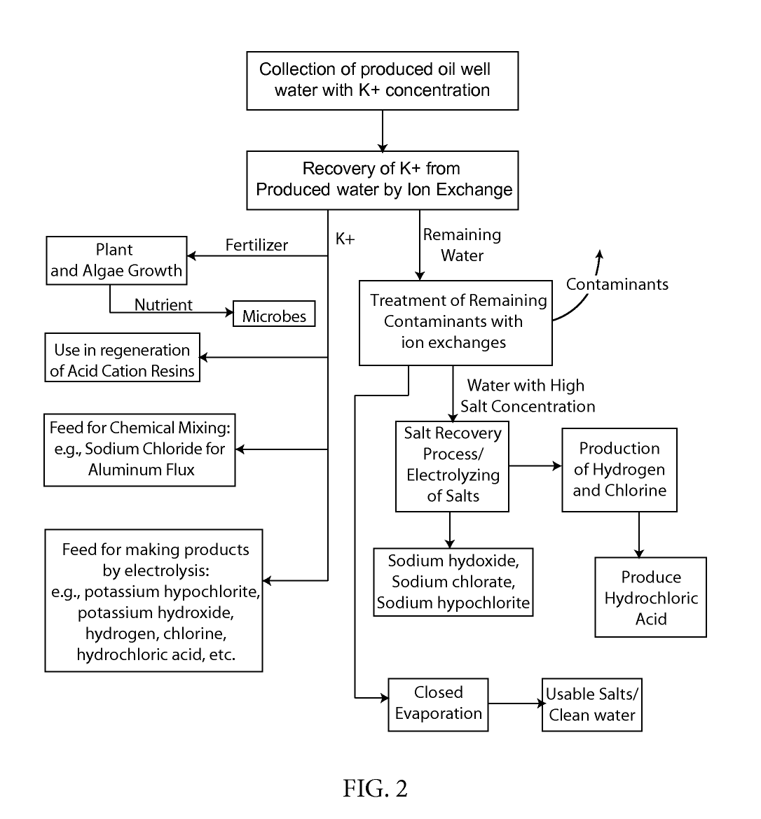

### DETAIL DESCRIPTIONS OF THE INVENTION

All illustrations of the drawings are for the purpose of describing selected versions of the present invention and are not intended to limit the scope of the present invention.

The present invention introduces the beneficial use of products recycled from waste waters through the example of recovery from the produced water from oil production. The waste waters typically consist of a plurality of different types of contaminants including calcium, magnesium, potassium, and sodium salts, and other contaminants. In addition to nitrogen, potassium is a major nutrient in which microbes, plants or algae utilize for growth and survival. The absorption of the contaminants in the waste waters by microbes, plants, and algae, along with evaporation, also reduces the volume of the water content in the produced water. As a result, the volume of waste water is decreased with higher concentration of the remaining salts. The reduced volume reduces the cost of disposal of the waste water. The other option of handling the remaining waste water is to recover the usable salts. The extraction of the nitrogen and the potassium contaminants from the waste waters with the result that ease of separation of the other salts is increased.

The present invention is a process for utilizing potassium extracted from waste waters. For the purpose of description of the produced water from oil wells is used as example waste water. The present invention offers two methods for the extraction of potassium from waste waters such as the water produced from the oil wells. Any calcium and magnesium will usually be removed with or before potassium. The first method of extraction is to supply the produced water directly to the secondary growth media in which the microbes, plants, or algae will grow in. The growth will naturally extract the potassium content from the water leaving behind a majority of the salt content for salts recovery by ion exchange, membrane separation, electrolytic processes, precipitation and/or evaporation. The second method is the separation of the potassium and the remaining contaminants from produced waters. This can be achieved by membrane separation, ion exchange, electrolysis, precipitation, evaporation, and electrolytic processing use of recycled salt products in ion exchange, precipitation, affecting precipitation from waste waters, or a combination of more than one of the listed processes. The separated potassium content and the remaining contaminants can be directly fed to the microbes, plants or algae to be consumed as nutrients. Each of these process, or combination of these processes, allow for greater productive use of the water before the salts concentration reaches the limit of beneficial use and require disposal or evaporation to recycle salts.

The following are two tables of compositions from two samples of water extracted from an oil well:

| | mg/L |
|---|---|
| Sample #1: Constituents | |
| Calcium, Ca | 3400 |
| Magnesium, Mg | 1000 |
| Sodium, Na | 5100 |
| Potassium, K | 2300 |
| Iron, Fe | 220 |
| Alkalinity as: | |
| Hydroxide, OH | 0 |
| Carbonate, CO3 | 0 |
| Bicarbonate, HCO3 | 1100 |
| Chloride, Cl | 17000 |
| Sulfate, SO4 | 83 |
| Sulfide, S | 6.7 |
| TOTAL (SUM) | 30000 |
| Sample #2: Constituents | |
| Calcium, Ca | 2800 |
| Magnesium, Mg | 820 |
| Sodium, Na | 4700 |
| Potassium, K | 1900 |
| Iron, Fe | 40 |
| Alkalinity as: | |
| Hydroxide, OH | 0 |
| Carbonate, CO3 | 0 |
| Bicarbonate, HCO3 | 1000 |
| Chloride, Cl | 14000 |
| Sulfate, SO4 | 46 |
| Sulfide, S | 4.3 |
| TOTAL (SUM) | 25000 |

| | mg/L |
|---|---|
| Sample #3: Constituents | |
| Calcium, Ca | 2800 |
| Magnesium, Mg | 820 |
| Sodium, Na | 4900 |
| Potassium, K | 1800 |
| Iron, Fe | 67 |
| Alkalinity as: | |
| Hydroxide, OH | 0 |
| Carbonate, CO3 | 0 |
| Bicarbonate, HCO3 | 1100 |
| Chloride, Cl | 14000 |
| Sulfate, SO4 | 30 |
| Sulfide, S | <1.0 |
| TOTAL (SUM) | 25000 |
| Sample #4: Constituents | |
| Calcium, Ca | 2700 |
| Magnesium, Mg | 800 |
| Sodium, Na | 4700 |
| Potassium, K | 1700 |
| Iron, Fe | 95 |
| Alkalinity as: | |
| Hydroxide, OH | 0 |
| Carbonate, CO3 | 0 |
| Bicarbonate, HCO3 | 1200 |
| Chloride, Cl | 13000 |
| Sulfate, SO4 | 30 |
| Sulfide, S | <1.0 |
| TOTAL (SUM) | 24000 |
| Sample #5: Constituents | |
| Calcium, Ca | 2600 |
| Magnesium, Mg | 780 |
| Sodium, Na | 4600 |
| Potassium, K | 1700 |
| Iron, Fe | 85 |
| Alkalinity as: | |
| Hydroxide, OH | 0 |
| Carbonate, CO3 | 0 |
| Bicarbonate, HCO3 | 1200 |
| Chloride, Cl | 13000 |
| Sulfate, SO4 | 30 |
| Sulfide, S | <1.0 |
| TOTAL (SUM) | 23000 |

These analyses of the produced water from the oil wells list the usable potassium content in the water. Microbes, plants, and algae are able to consume potash to very low levels depending on the type of algae, other factors, and conditions. Similarly, halophytic plants are able to consume potash from water depending on the type of environment and condition it is placed in. The present invention is a method for extracting or utilizing this potassium as fertilizer/nutrients for the growth of algae or halophytic plants. Even with the high sodium content present, the halophytic plants and/or algae are able absorb the necessary nutrients to grow.

To separate the potassium content and each of the plurality of remaining contaminants in usable form from the waste waters, it is preferred for the separation method to be the ion exchange method. This is because after the start up, all of the regeneration material for the ion exchange resins may be produced from the salts recycled from the produced water. The separated potassium content in combination with the plurality of remaining contaminants defines the potash. Ion exchange water treatments utilize a bed of ion media to attract and retain the contaminant inside water. The ion resins are insoluble polymer matrixes formed into small beads. The ion resins have a highly developed structure with a plurality of pores on its surface and most often within the resins are sites that are able to easily hold and release ions. The contaminated waters are coursed through a bed of ion resins while the ion resins attract and retain the contaminants from the passing water according to selectivity as determined by the method of manufacture. The contaminants are attracted and retained by the ion resins while the ion resins release salt in exchange for the contaminants. Alternatively, a Zeolite may be used for cation exchange. The contaminants are attracted and retained by the ion exchange resins while the resin releases ions in exchange for the contaminants. (The exception is weak base anion resin where the literature reports that weak base anion resin simply adsorbs the acid without ion exchange.) The potassium contaminants are removed via ion exchange and separately or combined with other elements that are useful or neutral as nutrients and/or as soil amendments. The other contaminants can be removed via other purification methods including membrane separation or electrolytic processing, or evaporation with fractional crystallization. As a result, the salt content of the produced water is reduced in kind and amount at each step in the system.

Potassium chloride can be used for regeneration of water softening resins and the typical product of regeneration is a mix of potassium-calcium-magnesium chloride useful for both fertilizer and for improving the Sodium Adsorption Ratio as shown in my previous U.S. Pat. No. 6,651,383B2 and U.S. Pat. No. 7,771,600B2. Potassium chloride can be used for regeneration of the strong base anion resin as used in removal of nitrates from water thereby recovering the nitrates in the form of the very expensive potassium nitrate. The treating of the salty waste water can produce a clean water stream and a waste water stream containing increased salt content. The electrolyzing of salts contained in the waste stream can provide chlorine produces such as chlorine, hypochlorites or chlorates and/or electrolysis byproducts such as sodium hydroxide, potassium hypochlorite, potassium hydroxide, hydrogen, chlorine, and hydrochloric acid. Additionally, the production of hydrogen as well as chlorine allows the production of hydrochloric acid. The hydrochloric acid may be used in the regeneration of both weak and strong cation resins. While the combustion process of making hydrochloric acid is occurring, large amounts of heat is released. This heat from can be stored and utilized as energy for a number of different applications. The sodium hydroxide can be used for the regeneration of either or both strong base anion resin and weak base anion resin. In this manner, water may be treated to high purity while retaining the value of the potash as fertilizer in the regeneration brine. After the removal of multivalent cations and the potassium, the remaining brine containing primarily sodium chloride, and the regeneration brines may be treated to separate purified water and more concentrated brines. Additionally, the conventional brine purification and evaporation practice may also be performed to produce high purity crystallized salts. The separate potassium can be used as nutrient for microbes, plants, and algae.

By introducing desirable elements, the growth of microbes, plants, and/or algae is significantly expedited for use in other fields. For example, in the field of microbial enhanced oil recovery, small plants grown from the waste water can be utilized as nutrients for feeding microbes to maximize the oil recovery efficiency. When consumed by the microbes, the status of the plants or algae is irrelevant as the microbes simply consume the small plants and algae as nutrients. Microbes can be fed and bred outside of the oil well or while they are already inside the oil formation. Microbial Enhanced Oil Recovery is an in-situ flooding method under utilization specific microorganisms that are able to digest hydrocarbons or generate various products that enhance the oil recovery process. However, for the microbes to enhance the oil recovery process, they require nutrients that further improve their efficiency and productivity. The practice of using microbes to recover oil works more efficiently when the nutrients are added through mixtures which are injected with the microbes into the oil production wells. Microbes are able to consume the nutrients from plants or algae whether they are dead or alive. As a result, regardless of the environment the microbes are in, the plants and/or algae are fed for the cultivation of microbes for oil recovery purposes. Algae are able to grown in fresh or even water much more salty than seawater, including produced water from oil and gas wells. This allows growing algae in the same waste water that can be circulated through the oil well to increase oil recover, a practice known as Microbial Enhanced Oil Recovery. In this way, the algae are used to feed microbes without external sources of water and without the high cost of separating the algae from the water in which it is grown. The oil well brine containing microbes along with algae if any remain or is added is injected into the oil well where microbial enhanced oil recovery is practiced.

The goal of the present invention includes the use of elements from water, previously discarded at high cost as waste, for production of microbes, plants and algae. Algae contain desired elements and nutrients that can be used for introduction to the food chain of selected microbes, plants, fish, fowl, animals, and humans. Not only are algae suitable for feeding microbes, plants and algae can be used as organic fertilizer.

In addition to its use as nutrition feed for microbes, plants, and algae, potassium can also be recycled in the form of potassium chlorides or potassium chlorite, chlorate, hypochlorite, and hydroxide. Potassium chlorides recovered from the waste waters can be utilized for regeneration of cation ion exchange media for water softening. The potassium hydroxides manufactured from recycled potassium chloride provide material for regeneration of both strong base and weak base anion resins. As a result, the supplies of fertilizer material that can be used in desalination is expanded and at a lower cost at point of use. It is recognized that the use of cation exchange resin regenerated using sulfuric acid or nitric acid produces potassium salts which are fertilizer and/or can be converted by electrolysis to produce sodium hydroxide and a strong acid for use in water purification, but this is included as reference. This allows for the expanding use of a chemical that is derived from recycled material to do the most advanced work required for meeting the specifications of ultra-pure water. While much energy is required for electrolysis of potassium in making potassium hydroxide, the energy is comparable to the energy used in producing sodium hydroxide as used in large volume to produce Ultra-pure water, and to purify water through adjustment of pH as required for removing silica by membrane separation or in precipitation of impurities.

U.S. Geological Services estimates that the supply of brackish ground water at 10 times the volume of the supply of fresh ground water that now supplies 80% of the water use in the U.S.A. Desalination of such brackish ground water using acids and hydroxides made from recycled salts can meets all degrees of desalination for potable use and even to the ultrapure water required for the least risk healthcare and in manufacturing of foods, medicines, skin care, and the numerous high technology products such as computer chips and other electronic products.

There has been little demand for potassium hydroxide for use in water purification due to high cost. The high costs are, in part, a result of few production operations which have very high standards for purity as used in foods and chemical grades. With few producers of potassium hydroxide as compared with producers of sodium hydroxide, freight is usually prohibitive. However, by generating a supply of potassium hydroxide from waste waters at or near points of use and with the complete use of the spent potassium hydroxides as fertilizer, following its use in water purification, the net costs of potassium use, including savings in cost of disposal of spent regeneration brine, can be driven down. As a result, both the ecological cost and monetary cost of disposal of the wastes from use of sodium hydroxide are avoided.

Although the invention has been explained in relation to its preferred embodiment, it is to be understood that many other possible modifications and variations can be made without departing from the spirit and scope of the invention as hereinafter claimed.

What is claimed is:

1. A method of Recovering Potassium from Waste Waters for Growing Microbes, Plants and Algae comprising the steps in combination of:
collecting waste waters with potassium content; and
separating of the potassium content from waste waters in a usable form in combination with the separation of a plurality of remaining contaminants in a usable form by means of a separation process, wherein the separated potassium content in combination with the remaining contaminants defines a potash.

2. The method of Recovering Potassium from Waste Waters for Growing Microbes, Plants and Algae as claimed in claim 1 comprises,
feeding and growing microbes, plants, and algae utilizing the potassium content directly from the waste waters.

3. The method of Recovering Potassium from Waste Waters for Growing Microbes, Plants and Algae as claimed in claim 1 comprises,
supplying of the waste waters to a secondary growth media, wherein the waste water supplies water and nutrients to the secondary growth media for growing microbes, plants, and algae and the potash is consumed as nutrients.

4. The method of Recovering Potassium from Waste Waters for Growing Microbes, Plants and Algae as claimed in claim 1 comprises,
separating of a plurality of multivalent cations from the waste waters using cation exchange resin regenerated to a produced potassium form using potassium chloride recycled from the waste waters, wherein the plurality of multivalent cations include calcium and magnesium.

5. The method of Recovering Potassium from Waste Waters for Growing Microbes, Plants and Algae as claimed in claim 4 comprises,
regenerating of the cation exchange resins using hydrochloric acid made from hydrogen and chlorine, wherein the hydrogen and chlorine is produced by electrolysis of potassium chloride recycled from the waste water; and
separating of the potassium content originally from the waste water along with the produced potassium from the cation exchange separation of the plurality of multivalent cations by means of the cation exchange resins.

6. The method of Recovering Potassium from Waste Waters for Growing Microbes, Plants and Algae as claimed in claim 5 comprises,
producing potassium hydroxide by electrolysis of the potassium chloride recycled from the waste water; and
treating any of the remaining produced acidic water using a strong base anion exchange resin or a weak base anion exchange resin as regenerated using the potassium hydroxide produced electrolysis of potassium chloride separated from waste waters.

7. The method of Recovering Potassium from Waste Waters for Growing Microbes, Plants and Algae as claimed in claim 2 comprises,
feeding of the plants and the algae grown for microbial consumption for microbial enhanced oil recovery using additions of the produced waste waters.

8. The method of Recovering Potassium from Waste Waters for Growing Microbes, Plants and Algae as claimed in claim 3 comprises,
feeding of the plants and the algae grown for microbial consumption for microbial enhanced oil recovery using additions of the produced waste waters.

9. The method of Recovering Potassium from Waste Waters for Growing Microbes, Plants and Algae as claimed in claim 1 comprises,
wherein the separation process is a water treatment method selected from the group consisting of ion exchanges, membrane separation, electrolysis, separation of salts, or precipitation.

10. A method of Recovering Potassium from Waste Waters for Growing Microbes, Plants and Algae comprising the steps in combination of:
collecting waste waters with potassium content; and
separating of the potassium content from waste waters in a usable form in combination with the separation of a plurality of remaining contaminants in a usable form by means of a separation process, wherein the separated potassium content in combination with the remaining contaminants defines a potash.
feeding and growing microbes, plants, and algae utilizing the potassium content directly from the waste waters;
supplying of the waste waters to a secondary growth media, wherein the waste water supplies water and nutrients to the secondary growth media for growing microbes, plants, and algae and the potash is consumed as nutrients; and
separating of a plurality of multivalent cations from the waste waters using cation exchange resin regenerated to a produced potassium form using potassium chloride recycled from the waste waters, wherein the plurality of multivalent cations include calcium and magnesium.

11. The method of Recovering Potassium from Waste Waters for Growing Microbes, Plants and Algae as claimed in claim 10 comprises,
regenerating of the cation exchange resins using hydrochloric acid made from hydrogen and chlorine, wherein the hydrogen and chlorine is produced by electrolysis of potassium chloride recycled from the waste water; and
separating of the potassium content originally from the waste water along with the produced potassium from the cation exchange separation of the plurality of multivalent cations by means of the cation exchange resins.

12. The method of Recovering Potassium from Waste Waters for Growing Microbes, Plants and Algae as claimed in claim 11 comprises,
producing potassium hydroxide by electrolysis of the potassium chloride recycled from the waste water; and
treating any of the remaining produced acidic water using a strong base anion exchange resin or a weak base anion exchange resin as regenerated using the potassium hydroxide produced electrolysis of potassium chloride separated from waste waters.

13. The method of Recovering Potassium from Waste Waters for Growing Microbes, Plants and Algae as claimed in claim 10 comprises,
feeding of the plants and the algae grown for microbial consumption for microbial enhanced oil recovery using additions of the produced waste waters.

14. The method of Recovering Potassium from Waste Waters for Growing Halophytic Plants and Algae as claimed in claim 10 comprises,
wherein the separation process is a water treatment method selected from the group consisting of ion exchanges, membrane separation, electrolysis, separation of salts, or precipitation.

15. A method of Recovering Potassium from Waste Waters for Growing Microbes, Plants and Algae comprising the steps in combination of:
collecting waste waters with potassium content; and
separating of the potassium content from waste waters in a usable form in combination with the separation of a plurality of remaining contaminants in a usable form by means of a separation process, wherein the separated potassium content in combination with the remaining contaminants defines a potash.
feeding and growing microbes, plants, and algae utilizing the potassium content directly from the waste waters;
supplying of the waste waters to a secondary growth media, wherein the waste water supplies water and nutrients to the secondary growth media for growing microbes, plants, and algae and the potash is consumed as nutrients;
separating of a plurality of multivalent cations from the waste waters using cation exchange resin regenerated to a produced potassium form using potassium chloride recycled from the waste waters, wherein the plurality of multivalent cations include calcium and magnesium;
regenerating of the cation exchange resins using hydrochloric acid made from hydrogen and chlorine, wherein the hydrogen and chlorine is produced by electrolysis of potassium chloride recycled from the waste water; and
feeding of the plants and the algae grown for microbial consumption for microbial enhanced oil recovery using additions of the produced waste waters.

16. The method of Recovering Potassium from Waste Waters for Growing Microbes, Plants and Algae as claimed in claim 15 comprises,
separating of the potassium content originally from the waste water along with the produced potassium from the cation exchange separation of the plurality of multivalent cations by means of the cation exchange resins;
producing potassium hydroxide by electrolysis of the potassium chloride recycled from the waste water; and
treating any of the remaining produced acidic water using a strong base anion exchange resin or a weak base anion exchange resin as regenerated using the potassium hydroxide.
